(19) United States
(12) Patent Application Publication
(10) Pub. No.: US 2026/0139849 A1
(43) Pub. Date: May 21, 2026

(54) PRODUCTS FOR DOSING HEATING SYSTEMS WITH CHEMICALS

(71) Applicant: ADEY HOLDINGS (2008) LIMITED, Stonehouse Gloucestershire (GB)

(72) Inventors: Caitlin DOYLE, Stonehouse Gloucestershire (GB); Josh BEANEY, Stonehouse Gloucestershire (GB); Mo JASSAL, Stonehouse Gloucestershire (GB)

(21) Appl. No.: 19/121,010

(22) PCT Filed: Nov. 8, 2023
(86) PCT No.: PCT/EP2023/081166

§ 371 Date: Apr. 14, 2025

(30) Foreign Application Priority Data
Dec. 1, 2022 (GB) 2218062.4

(51) Int. Cl. F24D 19/00; C02F 1/68; F24D 3/10

(52) U.S. Cl. CPC F24D 19/0092; C02F 1/686; F24D 3/1083

(57) ABSTRACT

It is proposed to provide a central heating system chemical, for example a corrosion inhibitor, silencer, cleaner, leak sealer, biocide, antifreeze, or descaler, in packaging which reduced material use and waste while providing convenient dosing. The chemicals have a high viscosity compared to known chemicals, for example between 500 cP and 2000 cP. The chemicals are packaged in a packaging made from a flexible material, such as a spout pouch or a foil sausage for use with a sealant gun.

The present invention relates to chemical products for central heating systems, in particular chemical products packaged in a bag or pouch to allow dosing.

### BACKGROUND TO THE INVENTION

A range of chemicals are available for treating central heating system water. Most commonly, a corrosion inhibitor is added to central heating system water to reduce corrosion of metal parts. A silencer may be used to treat noisy systems, and cleaners, leak sealers, biocides, antifreezes, and descalers may be used in heating systems to address specific problems.

Typically the chemical is provided as a flowable liquid and packaged in a plastic bottle. It can be added to the system by removing the plug from the top of a radiator (typically two plugs are provided, one on either side of a radiator, one of which includes the bleed valve) and pouring the liquid into the radiator. Sometimes, for example on towel warmers, a plug is provided facing upwards, which is ideal. However, more commonly the plugs at the top of an ordinary radiator face horizontally. Therefore some sort of funnel/pipe arrangement is required to dose the liquid chemical in this way.

Chemicals may also be dosed through a heating system filter. The filter can provide a convenient dosing point. The filter can be isolated from the system, drained, and then the lid opened and the chemical added to fill the filter. The lid is then replaced and the filter reconnected to the heating system circuit, to circulate the chemical throughout the system.

However, this only works with certain types of filter, specifically those with removable upward-facing lids. Also, unless a very large filter has been installed for the size of heating system, the filter is not typically large enough to take an entire dose of chemical at one time. Therefore, the process (of isolating and draining the filter, removing the lid, dosing the chemical, closing the lid, opening the valves, bleeding the filter) will need to be repeated.

More recently chemicals have been packaged in canisters which include a compressed gas to force the chemical out of the canister, and typically have a nozzle with a screw fitting so that the canister can be attached directly to a radiator with the plug removed. The compressed gas may be pressurised to, for example, 10 bar, which is far more than the system pressure in most central heating systems. Typically, a radiator is isolated and the plug removed. The canister is connected to the radiator and then the radiator valves are opened again. A trigger on the canister can then be pressed to force the chemical out of the canister, against the system pressure, and into the central heating system. After the chemical has been allowed to circulate around the system, the radiator can be isolated by its valves, the canister disconnected, the plug replaced, and then the radiator valves opened again.

This type of packaging makes dosing considerably easier, in some cases avoiding the need to drain anything out of the system or depressurise it. However, the packaging is more expensive. Also, the compressed gas packages are made from mixed materials including metal and plastics which are difficult to separate. These packages are not easily recyclable, or are only partially recyclable.

The more traditional chemical packaging uses plastic bottles which are more easily recyclable. However, there is still a need to reduce the amount of plastic material used.

It is an object of the present invention to provide a chemical product in a packaging format which is easy and convenient to use, and also reduces use of plastic packaging.

### STATEMENT OF INVENTION

According to the present invention there is provided a packaged chemical product for dosing a central heating system, the product comprising:
a liquid-tight pouch made from a flexible material, the pouch including an outlet in the form of a spout,
a chemical for use in a central heating system, the chemical being provided inside the pouch, and the chemical having a viscosity greater than 500 cP, or being in the form of a flowable powder or granular material.

The chemical is considerably more viscous than current heating system chemicals which are provided in plastic bottles. This has two implications. Firstly, it means that the flexible pouch is easier to handle, to squeeze the chemical out of the pouch and into a heating system, for example through the top of a radiator, without spillage. Because of the higher viscosity, the introduction of the chemical into the system is easier to control, which is a significant advantage particularly when it is being dosed through an opening an a hard-to-reach place. Secondly, the chemical is more concentrated, which means that a smaller volume is used to treat a central heating system. For example, typically a 500 ml bottle of liquid corrosion inhibitor will be suitable for treating a typical household central heating system of up to about 15 radiators. Note that 500 ml is more than the capacity of the filter that would typically be installed in a central heating system of this size. However, with a more concentrated and therefore more viscous chemical, in one embodiment 235 ml provides the same effect. This allows for a size of pouch which is convenient to handle. For example, a rectangular pouch measuring less than around 150 mm×200 mm, and which expands to less than 100 mm thick when filled, is suitable. In one embodiment, a 235 ml pouch is provided which measures 105 mm×165 mm, and expands to less than 50 mm thick when filled.

The applicant's pending application published as GB2591292 describes how more concentrated inhibitors can be produced.

The pouch is made from a flexible material, for example soft plastics such as LDPE or PP. This allows the chemical inside the pouch to be squeezed out into (for example) a radiator. These plastics are fully recyclable, and much less material is used compared to the traditional rigid plastic bottles which are currently used to package central heating chemicals.

The spout is preferably in the form of a rigid tube, for example made from plastics such as rigid LDPE. Thus the whole pouch, including the spout, can be recycled in the same recycling stream.

Providing the spout in the form of a rigid tube allows the outlet to be easily manipulated into position into an opening, for example at the top of a radiator. The outlet from the spout can then be held in position while the liquid chemical in the pouch is poured and/or squeezed into the heating system.

A spout in the form of a rigid tube may be closed by a screw cap. The screw cap is preferably made from the same material as the tube. After use, the screw cap can be replaced on the tube, and the whole of the packaging recycled together with no separation being required for recycling in a soft LDPE stream.

The spout is preferably disposed on the pouch such that, when the pouch is oriented so that the spout is horizontal, a majority of the volume of the pouch is above the spout. Preferably more than 75% or more than 80% of the volume of the pouch is above the spout when the spout is horizontal. One way of configuring the spout on the pouch is to have a substantially rectangular pouch, having two long sides and two short sides, with one of the corners of the pouch being truncated by a fifth side which extends at about 45 degrees to each of the adjacent long side and short side. The spout extends perpendicularly from the fifth side, and is therefore at 45 degrees to each of the long and short sides of the rectangle.

This type of package is often known as a corner spout pouch.

The chemical has a viscosity of more than 500 cP, but may be more than 750 cP, more than 1000 cP or more than 1500 cP.

Preferably, the chemical has a viscosity of less than 2000 cP.

A viscosity in the range of 500 cP to 2000 cP is found to be convenient to allow the liquid chemical to be controlled as is expelled from the pouch by pouring/squeezing. It is a noticeably more viscous liquid than current chemicals sold in plastic bottles, and this helps to dose the system from a flexible pouch while avoiding accidental spillage. However it is not so viscous that it will not flow, and it can be poured in a controlled way into a central heating system.

The chemical as a whole flows like a liquid in the viscosity range indicated. In fact the chemical may be a colloid and/or contain some solid particles.

As an alternative to a viscous fluid, the chemical may be a flowable powder or granular material.

The chemical may be a corrosion inhibitor. The chemical may be a silencer. The chemical may be a cleaner. The chemical may be a leak sealer. The chemical may be a biocide. The chemical may be an antifreeze. The chemical may be a descaler. The chemical may include any combination of corrosion inhibitor, silencer, cleaner, leak sealer, biocide, antifreeze and descaler.

According to a second aspect of the invention, there is provided a method of dosing a central heating system with a chemical having a viscosity greater than 500 cP, or being in the form of a flowable powder or granular material, the method comprising:
providing the chemical in a liquid-tight pouch made from a flexible material, the pouch including an outlet in the form of a spout;
positioning the outlet of the spout at a dosing point associated with the central heating system, and squeezing the pouch to expel the chemical from the pouch into the central heating system.

Preferable/optional features of the second aspect of the invention are set out in claims 13 to 15.

According to a third aspect of the invention, there is provided a method of dosing a central heating system with a chemical having a viscosity greater than 20,000 cP, the method comprising:
providing the chemical in a flexible wrapper adapted for use with a foil sausage sealant gun;
opening an end of the wrapper and loading the wrapped chemical into the foil sausage sealant gun;
positioning an outlet of the foil sausage sealant gun at a dosing point associated with the central heating system, and operating the gun to expel the chemical from the gun into the central heating system.

Foil sausage sealant guns are now well known for use with sealants, fillers, adhesives and the like. The wrapper is typically made from a multi-layer material including aluminium foil and plastics, for suitably protecting the chemical when in storage. The chemical is packaged in the wrapper which when filled is substantially cylindrical with rounded ends (i.e. like a sausage). The wrapper is sealed at both ends for storage. When ready for use, an end is opened, for example by cutting with a pair of scissors, and the wrapped chemical is loaded into the sealant gun. The outlet of the gun, which may be in the form of a nozzle, is then positioned to dose the chemical into the heating system, for example through an opening in the top of a radiator.

The packaging in this case is particularly low cost, and it uses a very small amount of material to produce. The wrapper could potentially be made from recyclable materials, for example soft plastics.

While the foil sausage packaging format reduces waste and material use, it is still convenient for use since a suitable applicator gun is now a common tool which many tradespersons will already own.

For packaging in this format, chemicals need to be produced which have a higher viscosity compared to known central heating chemicals. Methods of producing a corrosion inhibitor with suitable high viscosity are described in the applicant's pending application GB2591292.

The chemical has a viscosity of more than 20,000 cP, but may be more than 30,000 cP, more than 40,000 cP or more than 50,000 cP.

Preferably, the chemical has a viscosity of less than 100,000 cP. The chemical with a viscosity in this range may be described as a thick cream.

The chemical may be a colloid and/or contain some solid particles.

The chemical may be a corrosion inhibitor. The chemical may be a silencer. The chemical may be a cleaner. The chemical may be a leak sealer. The chemical may be a biocide. The chemical may be an antifreeze. The chemical may be a descaler. The chemical may include any combination of corrosion inhibitor, silencer, cleaner, leak sealer, biocide, antifreeze and descaler.

An electric sealant gun may be used. These are typically powered by rechargeable batteries and reduce labour, especially if a large amount of chemical needs to be dosed into the central heating system. It is envisaged that a 600 ml pack may treat a 500 L system (i.e. a volume/volume dose ratio of 0.12%). However large commercial systems may need multiple packs for correct dosing. An electric sealant gun may also make it easier to precisely position the nozzle for dosing, reducing the possibility of spillage.

In some embodiments, the outlet of the sealant gun is connected into the central heating system circuit with a fluid-tight fitting. For example, a BSP thread may be provided for connecting the outlet of the sealant gun by screwing it into a radiator with the plug removed, or into the filling loop of a heating system, or onto a drain point. Preferably, a non-return valve is provided between the sealant gun and the central heating system. A flexi hose may be provided to connect the outlet of the sealant gun to the heating system, which means that only a limited amount of space needs to be available around the chosen dosing point to successfully manipulate the sealant gun and introduce the chemical into the heating system.

By connecting the sealant gun to the central heating system in this way, it can be used to force the chemical into the system against the system pressure. It is found that a manual sealant gun can be used to do this in many domestic heating systems (typically pressurised to about 1 bar). Electric sealant guns can be used to dose even high-pressure commercial heating systems (which may be pressurised to about 5 bar or even more in some cases).

The foil sausage format, for use with sealant guns, is particularly useful for larger heating systems, for example heating systems in commercial buildings. The quantity of chemical in a single package may be for example around 400 ml-600 ml and is highly concentrated. A single package may be sufficient to dose a heating system with for example around 30 radiators or more. Multiple packages may be provided for dosing larger systems. A further advantage of the foil sausage format is that different sized packages can be made to be compatible with the same applicator gun, simply by making the foil sausages different lengths. This further reduces waste because the correct amount of chemical required can be calculated, and only packets containing that amount can be opened and used. For example, if 400 ml (“full size”), 200 ml (“half size”) and 100 ml (“quarter size”) packages are provided, then any quantity of chemical to the nearest 100 ml can be dosed into the system, so that the correct amount can be used without leaving unused product in opened packaging.

According to a fourth aspect of the invention, a packaged chemical product is provided for use with the method of the third aspect of the invention. The packaged chemical product comprises a chemical having a viscosity of greater than 20,000 cP, packaged in a flexible wrapper closed at each end to form a substantially cylindrical package.

Preferable/optional features of the fourth aspect of the invention are set out in claims 21 and 22.

### BRIEF DESCRIPTION OF THE DRAWINGS

For a better understanding of the present invention, and to show more clearly how it may be carried into effect, reference will now be made by way of example only to the accompanying drawings, in which:

FIG. 1 is a perspective view of a corrosion inhibitor provided in a spout pouch, according to the first aspect of the invention;

FIG. 2 shows the packaged corrosion inhibitor product of FIG. 1, in use to dose a central heating system with the chemical via a radiator;

FIG. 3 shows the packaged corrosion inhibitor product of FIG. 1, in use to dose a central heating system with the chemical via a filter;

FIG. 4 is a perspective view of a corrosion inhibitor provided in a foil sausage, according to the fourth aspect of the invention;

FIG. 5 shows the packaged corrosion inhibitor product of FIG. 4, loaded into an applicator gun and in use to dose a central heating system with the chemical via a radiator; and

FIG. 6 shows the packaged corrosion inhibitor product of FIG. 4, loaded into an applicator gun and in use to dose a central heating system with the chemical via a filter.

### DESCRIPTION OF PREFERRED EMBODIMENTS

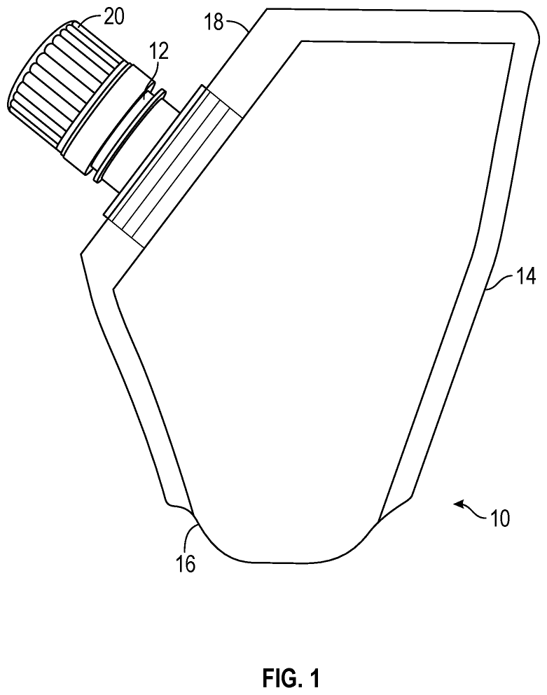

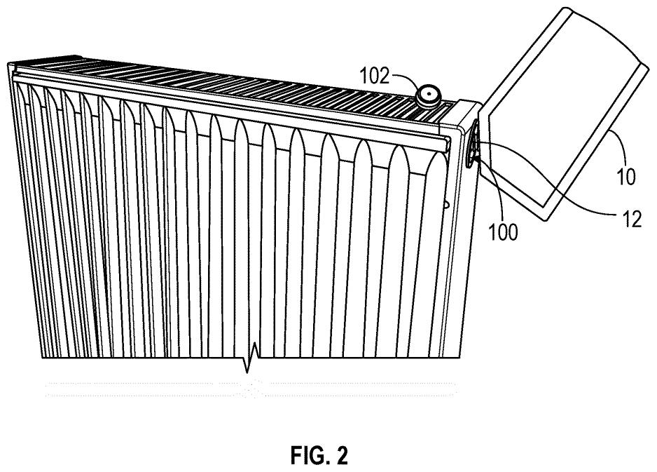

Referring firstly to FIG. 1, a corrosion inhibitor product packaged in a spout pouch is indicated generally at 10. The spout pouch is substantially rectangular but with a truncated corner where the spout 12 is provided. The rectangle (ignoring the truncated corner) has a long side 14 and a short side 16, and two further sides opposite each of the long side 14 and the short side 16. The long side measures around 165 mm high and the pouch is around 105 mm wide along the short side. A base panel is provided so that the pouch can stand on a surface, as shown in the drawing. When filled, the pouch expands to around 50 mm thick.

The pouch is made from soft plastics, for example soft LDPE. The pouch is flexible so that chemical can be squeezed out of the pouch and so that the pouch when empty takes up minimal space in a waste processing stream.

The truncated corner forms a fifth side 18 of the pouch. The fifth side 18 is preferably at around 45 degrees to each of the short side 16 and the long side 14. The spout 12 extends from the fifth side 18, substantially perpendicularly from the fifth side 18.

The spout has a screw cap 20 which is removable for use of the product to dose a heating system.

The position of the spout means that when the package 10 is inverted, the spout is disposed at around 45 degrees to the horizontal, and the vast majority of the pouch is above the spout and to the side of the spout. This, as shown in FIG. 2, is a very convenient position in particular for dosing a central heating system through a radiator port 100 from which a plug/bleed valve 102 has been removed. For use, the screw cap 20 is removed from the spout 12 and the spout 12 is inserted into the port 100.

The screw cap 20 may be removed and the spout 12 inserted into the port 100 with the pouch 10 in an upright position (i.e. with the spout at the top as shown in FIG. 1). The pouch 10 may then be inverted to the position shown in FIG. 2, so that the chemical into the pouch can flow into the radiator. The chemical in the pouch preferably has a viscosity of between 500 cP and 2000 cP, and this is found to be an ideal range since the chemical can flow, but in a more controllable way than current chemical products with low viscosity. The flexible pouch can be squeezed to expel all of the chemical from the pouch to ensure the system is properly dosed and avoid wasting unused chemical.

The pouch 10, including the spout 12, is made from LDPE. This can be recycled in a single stream without separating the spout 12 from the pouch 10.

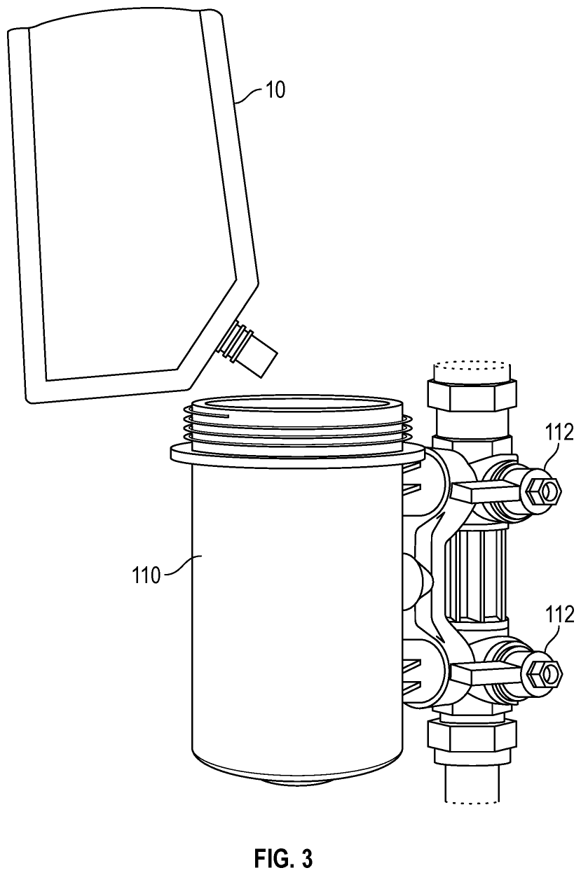

FIG. 3 shows the same pouch 10, being used to dose a central heating system via a filter 110. A filter provides a convenient dosing point in a central heating system, since valves 112 are typically provided on the inlet and outlet to the filter so that it can easily be isolated. The filter can be drained by a drain port, the lid removed, and then the filter canister filled with chemical. However, one drawback is that the amount of chemical needed to dose a heating system is typically a larger volume than the typical capacity of a filter associated with that size of heating system. Therefore the process needs to be repeated. However, because the chemical packaged in the pouch 10 can be more viscous than a chemical packaged in a rigid plastic bottle, it can be made to be more concentrated. In an embodiment a corrosion inhibitor can be made with a suitable concentration such that 235 ml can dose an average household system of up to 15 radiators. 235 ml is less than the capacity of a filter typically associated with such a heating system. Therefore only a single dosing operation is required.

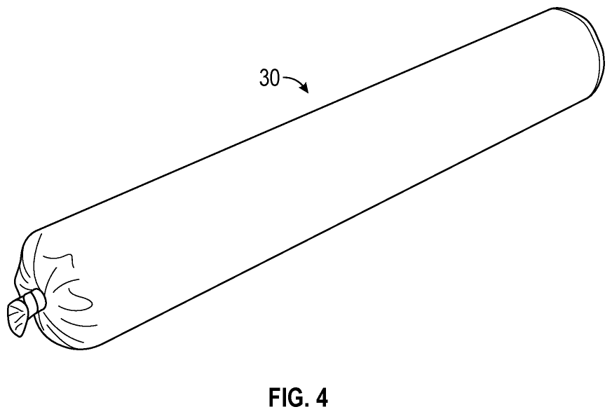

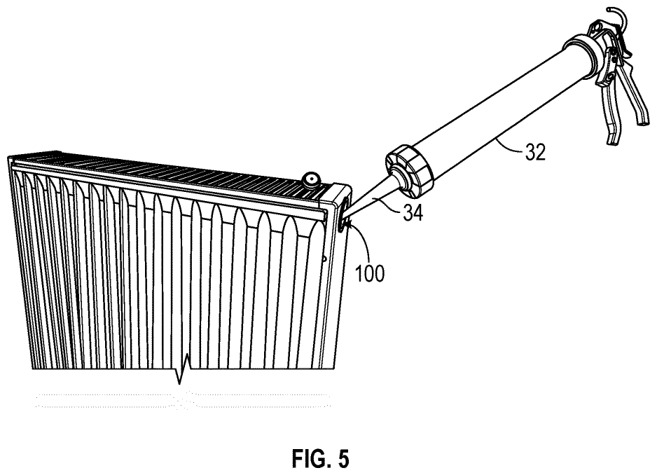

FIG. 4 shows a corrosion inhibitor product packaged in a foil sausage 30. Similar to known packaging for sealants, fillers and adhesives, the inhibitor product is enclosed in a wrap to form a substantially cylindrical shape. Advantageously, the package can be made any length up to a maximum length to fit in a sealant gun. The maximum size is typically equivalent to a volume of product encapsulated in the foil of around 400-600 ml. However, smaller (shorter) packages can be made so that smaller systems can be dosed without leaving unused product in an open package.

The package is closed at both ends, typically by a crimped collar. The package can be opened easily simply by cutting off the crimped end, for example using a pair of scissors.

The viscosity of the inhibitor product may be similar to a cream, for example more than 20,000 cP. This allows for use with a sealant gun to control dosing of a system without any spillage.

When the chemical has been dosed into the system, only a small compressed lump of foil is left in the applicator gun. This represents a very small amount of packaging waste.

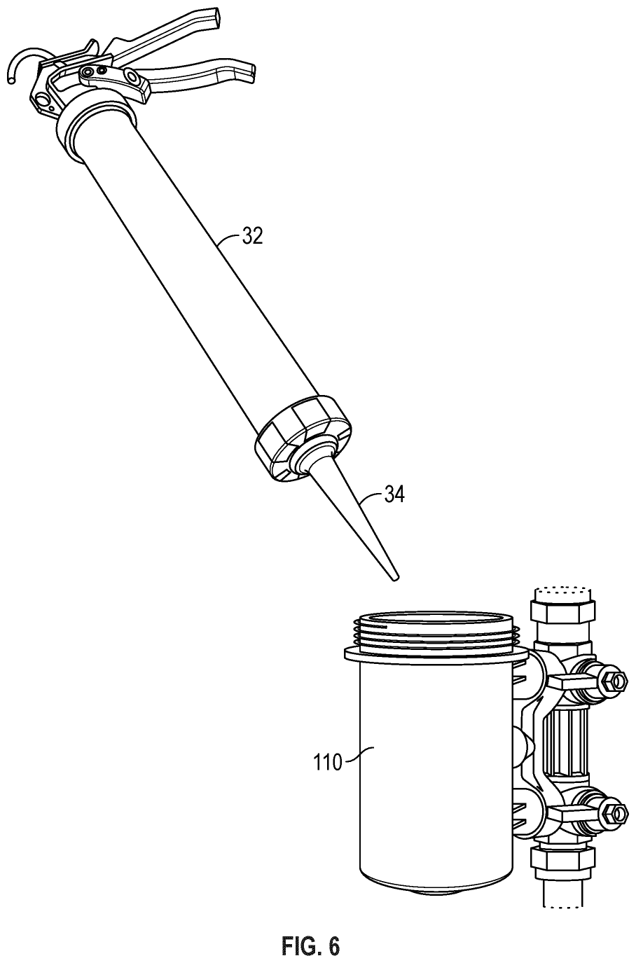

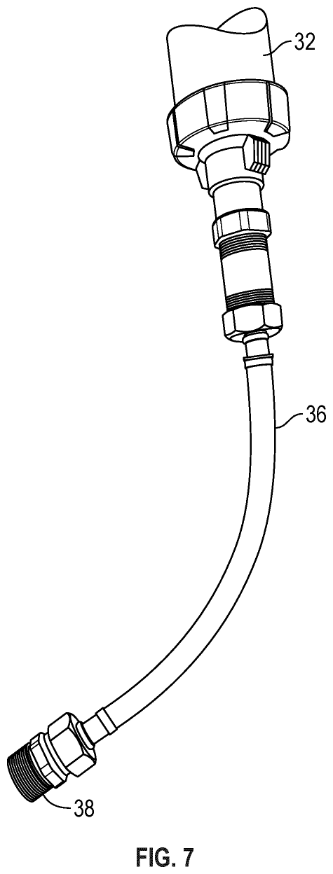

As shown in FIG. 5 and FIG. 6, the foil sausage package can be loaded into an applicator gun 32. The nozzle 34 of the applicator gun can then be positioned at a dosing point, for example a port 100 at the top of a radiator or an open end of a filter 110 with the lid removed. When the nozzle 34 is in the right position, the handle of the applicator gun can be squeezed to dispense the chemical. This provides an easy way of dosing a system, without spillage.

FIG. 7 shows the applicator gun 32, with a flexi hose 36 and threaded BSP fitting 38 attached in place of the nozzle (34), for fluid-tight connection into a central heating system. A non-return valve is also preferably provided. The applicator gun 32 in this configuration may be used similarly to known pressurised canisters. For example, a radiator may be isolated from the heating system by closing the radiator valves, then the plug near the top can be removed from the radiator. The threaded fitting 38 is then screwed into the radiator into the port from which the plug was removed (alternative fittings may be provided for fitting to alternative points on heating systems, for example fittings to mate with drain valves). The radiator valves are then opened, and the applicator gun 32 is used to force the chemical into the heating system against the system pressure. Good quality electric guns have been found to provide enough pressure to easily overcome over 10 bar in large commercial systems. Manual guns may be suitable for small domestic systems which are typically pressurised for example to about 1 bar. If multiple packets are required to fully dose a large system, the old empty packet can be removed from the gun 32 and a new packet inserted, without disconnecting the gun from the heating system or opening or closing any valves. Once the correct quantity of chemical has been dosed, the radiator valves (or drain valve, or another valve depending on the dosing point use) can be closed, the gun disconnected, the plug replaced, and the radiator valves then opened again.

Electric (usually cordless, battery powered) applicator guns are also available and provide an even more convenient dosing mechanism. Since there is no need to squeeze a handle both hands are available to control precisely the position of the nozzle, which may help to avoid spillage especially where the dosing port is in an awkward position.

The embodiments described above are provided by way of example only, and various changes and modifications will be apparent to persons skilled in the art without departing from the scope of the present invention as defined by the appended claims.

1-25. (canceled)

26. A method of dosing a central heating system with a chemical having a viscosity greater than 20,000 mPa·s, the method comprising:
providing the chemical in a flexible wrapper closed at each end to form a substantially cylindrical package with rounded ends and adapted for use with a foil sausage sealant gun;
opening an end of the wrapper and loading the wrapped chemical into a foil sausage sealant gun, the gun having an outlet in the form of a nozzle;
positioning the nozzle of the foil sausage sealant gun at a dosing point associated with the central heating system, and operating the gun to expel the chemical from the gun into the central heating system.

27. A method as claimed in claim 26, wherein the wrapper is made at least in part from aluminium.

28. A method as claimed in claim 26, wherein the dosing point is a port on a radiator.

29. A method as claimed in claim 26, wherein the dosing point is a filter with a lid removed.

30. A method as claimed in claim 26, wherein the outlet of the sealant gun is connected into the central heating system by means of a fluid-tight fitting.

31. A method as claimed in claim 30, wherein a non-return valve is connected between the outlet of the sealant gun and the central heating system.

32. A method as claimed in claim 30, wherein a flexi-hose is provided for connecting the outlet of the sealant gun into the central heating system.

33. A packaged chemical product for use in the method of claim 26, the product comprising a chemical having a viscosity of greater than 20,000 cP, packaged in a flexible wrapper closed at each end to form a substantially cylindrical package with rounded ends, and in which the chemical includes any of a corrosion inhibitor, a silencer, a cleaner, a leak sealer, a biocide, an antifreeze, and a descaler, suitable for use in treating central heating system water.

34. A product as claimed in claim 33, wherein the wrapper is made at least in part from aluminium.

35. A product as claimed in claim 33, wherein the viscosity of the chemical is at least 30,000 cP, preferably more than 40,000 cP or more than 50,000 cP.
